(19) United States
(12) Patent Application Publication
(10) Pub. No.: US 2020/0202412 A1
(43) Pub. Date: Jun. 25, 2020

(54) ORDERING SUPPLIES ON LOCATION

(71) Applicant: QUIX SUPPLY INC., NEWPORT BEACH, CA (US)

(72) Inventors: Gregory A. Barela, Irvine, CA (US); Richard A. Armstrong, Costa Mesa, CA (US); John Cronin, Williston, VT (US); Joseph Bodkin, Williston, VT (US)

(21) Appl. No.: 16/721,570

(22) Filed: Dec. 19, 2019

Related U.S. Application Data
(60) Provisional application No. 62/782,267, filed on Dec. 19, 2018.

(51) Int. Cl. G06Q 30/06; G06Q 10/08

(52) U.S. Cl. CPC G06Q 30/0635; G06Q 10/0835

(57) ABSTRACT

A platform for contractors, suppliers and other vendors to significantly improve the job purchasing workflow in real-time. This concept is a jobsite delivery service for contractors that has same day delivery directly to the contractor's jobsite. This service is integrated into a mobile platform for payments, processing, scheduling, tracking, fulfillment and accounting. Allowing the foreman to purchase item(s) nearby without losing productivity on the jobsite, as well as incorporating the receipts and updating a project budget and schedule, respectively, as needed.

### CROSS-REFERENCE TO RELATED APPLICATION

The present application claims the priority benefit of U.S. provisional patent application 62/782,267 filed Dec. 19, 2018, the disclosure of which is incorporated herein by reference.

### FIELD OF THE DISCLOSURE

The present disclosure is generally related to a construction platform solution in which contractors can locate, order, receive supplies from nearby vendors for items that are needed to complete a project.

### BACKGROUND

The subject matter discussed in the background section should not be assumed to be prior art merely as a result of its mention in the background section. Similarly, a problem mentioned in the background section or associated with the subject matter of the background section should not be assumed to have been previously recognized in the prior art. The subject matter in the background section merely represents different approaches, which in and of themselves may also correspond to implementations of the claimed technology.

The current system for contractors to order parts on a jobsite is inefficient and adds additional costs, especially from the cost of having workers wait till the part is on the jobsite. In the majority of cases, the foreman must leave the jobsite in order to pick up the part while the employees still collect their hourly rate even though productivity stops. The current invention assists in allowing the foreman to look up the part on his/her user device, locate and determine its availability at nearby stores and have the item delivered to the jobsite while maintaining productivity from the employees.

The value for this concept is the increase in efficiency for employees on a jobsite since the foreman or contractor isn't required to leave the jobsite for an item that could potentially hold up progress on the current project.

### BRIEF DESCRIPTIONS OF THE DRAWINGS

The accompanying drawings illustrate various embodiments of systems, methods, and embodiments of various other aspects of the disclosure. Any person with ordinary skills in the art will appreciate that the illustrated element boundaries (e.g. boxes, groups of boxes, or other shapes) in the figures represent one example of the boundaries. It may be that in some examples one element may be designed as multiple elements or that multiple elements may be designed as one element. In some examples, an element shown as an internal component of one element may be implemented as an external component in another, and vice versa. Furthermore, elements may not be drawn to scale. Non-limiting and non-exhaustive descriptions are described with reference to the following drawings. The components in the figures are not necessarily to scale, emphasis instead being placed upon illustrating principles.

FIG. 1: Illustrates a Contractor Based Ordering Platform, according to an embodiment.

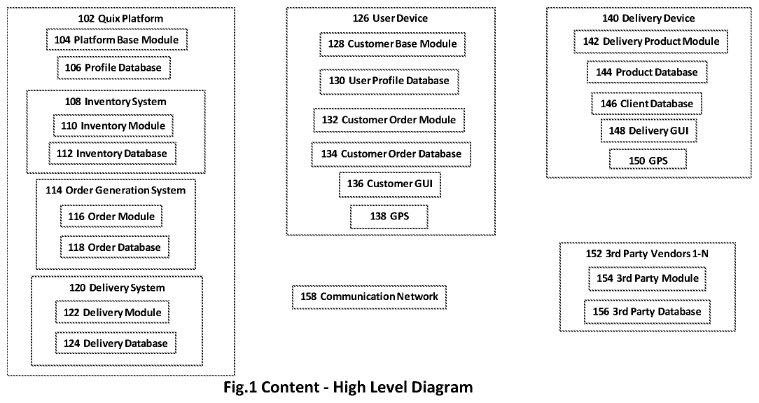

FIG. 2: Illustrates an Ordering Platform Base Module, according to an embodiment.

FIG. 3: Illustrates an Ordering Platform Profile Database, according to an embodiment.

FIG. 4: Illustrates an Ordering Platform Inventory Module, according to an embodiment.

FIG. 5: Illustrates an Ordering Platform Inventory Database, according to an embodiment.

FIG. 6: Illustrates an Ordering Platform Order Module, according to an embodiment.

FIG. 7: Illustrates an Ordering Platform Order Database, according to an embodiment.

FIG. 8: Illustrates an Ordering Platform Delivery Module, according to an embodiment.

FIG. 9: Illustrates an Ordering Platform Delivery Database, according to an embodiment.

FIG. 10: Illustrates an Ordering Platform Customer Base Module, according to an embodiment.

FIG. 11: Illustrates a User Device User Profile Database, according to an embodiment.

FIG. 12: Illustrates a User Device Customer Order Module, according to an embodiment.

FIG. 13: Illustrates a User Device Customer Order Database, according to an embodiment.

FIG. 14: Illustrates a Delivery Device Delivery Product Module, according to an embodiment.

FIG. 15: Illustrates a Delivery Device Product Database, according to an embodiment.

FIG. 16: Illustrates a Delivery Device Client Database, according to an embodiment.

FIG. 17: Illustrates a 3^{rd} Party Vendor 3rd Party Module, according to an embodiment.

FIG. 18: Illustrates a 3^{rd} Party Vendor 3rd Party Database, according to an embodiment.

### DETAILED DESCRIPTION

Some embodiments of this disclosure, illustrating all its features, will now be discussed in detail. The words “comprising,” “having,” “containing,” and “including,” and other forms thereof, are intended to be equivalent in meaning and be open ended in that an item or items following any one of these words is not meant to be an exhaustive listing of such item or items, or meant to be limited to only the listed item or items.

It must also be noted that as used herein and in the appended claims, the singular forms “a,” “an,” and “the” include plural references unless the context clearly dictates otherwise. Although any systems and methods similar or equivalent to those described herein can be used in the practice or testing of embodiments of the present disclosure, the preferred, systems and methods are now described.

Embodiments of the present disclosure will be described more fully hereinafter with reference to the accompanying drawings in which like numerals represent like elements throughout the several figures, and in which example embodiments are shown. Embodiments of the claims may, however, be embodied in many different forms and should not be construed as limited to the embodiments set forth herein. The examples set forth herein are non-limiting examples and are merely examples among other possible examples.

This is a method for a Contractor Based Ordering Platform 102. This system comprises of a Contractor Based Ordering Platform 102 that allows customers to search through inventory of connected 3rd Party Vendors 152 for materials and supplies, place orders at the 3rd Party Vendors 152, allow payment for the materials and supplies, provide a delivery service in which a person(s) pickups the ordered materials and supplies and delivers them to the job site. A Ordering Platform Base Module 104 which connects the various aspects of the Contractor Based Ordering Platform 102, such as the Ordering Platform Inventory System 108, Ordering Platform Order Generation System 114, and Ordering Platform Delivery System 120 as well as communicates to the customer through the User Device 126 via the Communication Network 158 to receive the customer User Device User Profile Database 130 for payment options and the customer order. An Ordering Platform Profile Database 106 which contains the payment options for the various users of the platform. An Ordering Platform Inventory System 108 in which connects to the various 3rd Party Vendors 152 to collect inventory data and allow the customer to search the available inventory through the Ordering Platform Base Module 104. An Ordering Platform Inventory Module 110 which provides access to the customer to provide them with the ability to search and select available materials and supplies from local 3rd Party Vendors 152. An Ordering Platform Inventory Database 112 which contains product information received from the 3rd Party Vendors 152 and stores the data on the Ordering Platform 102 to allow customers to search the available inventory at local 3rd Party locations. An Ordering Platform Order Generation System 114 which collects and stores the selected inventory materials and supplies from the Ordering Platform Inventory System 108, allows the payment from the customer and provides the customer order to the Delivery Device 140 or the 3rd Party location. An Ordering Platform Order Module 116 which collects and stores the customer's selection of inventory in the Ordering Platform Order Database 118 from the User Device Customer Order Database 134, processes the payment for the order, and either provides the Delivery Device 140 or 3rd Party Vendor 152 with the order to be either picked up or delivered. An Ordering Platform Order Database 118 which contains the product information for the materials and supplies that the customer has selected from the Inventory System 108. An Ordering Platform Delivery System 120 that receives the customer information and customer order via the Ordering Platform Order Generation System 114 and provides the Delivery Device 140 with the store location, job site location, materials and supplies ordered from the customer, payment and directions. An Ordering Platform Delivery Module 122 which receives the customer order and store location from the Ordering Platform Order Generation System 114, payment from the User Device 126, and directions to the 3rd Party Vendor 152 as well as the job site. An Ordering Platform Delivery Database 124 which contains the customer order, payment option, and GPS locations of the 3rd Party Vendor 152 and job site. A User Device 126 such as a laptop, smartphone, table, computer, or smart speaker. A User Device Customer Base Module 128 which connects to the Ordering Platform 102, allows the customer to input GUI options such as payment options and profile inputs, and initiates the User Device Customer Order Module 132. A User Device User Profile Database 130 which contains the payment information for the customer. A User Device Customer Order Module 132 in which the customer connects to the Ordering Platform Inventory System 108 in the Ordering Platform 102 and selects materials and products via the User Device Customer GUI 136 that are stored in the User Device Customer Order Database 134 and sent to the Ordering Platform Order Generation System 114 in the Ordering Platform 102. The User Device Customer Order Database 134 which contains the items or products inputted by the user via the User Device Customer GUI 136. The User Device Customer GUI 136 or graphical user interface(s) may either accept inputs from users or provide outputs to the users or may perform both the actions. In one case, a user can interact with the interface(s) using one or more user-interactive objects and devices. The user-interactive objects and devices may comprise user input buttons, switches, knobs, levers, keys, trackballs, touchpads, cameras, microphones, motion sensors, heat sensors, inertial sensors, touch sensors, or a combination of the above. Further, the interface(s) may either be implemented as a Command Line Interface (CLI), a Graphical User Interface (GUI), a voice interface, or a web-based user-interface. A User Device GPS 138 or Global Positioning System which is used to determine the location of the User Device 126. A Delivery Device 140 may be any type of user device used by the delivery driver such as a laptop, smartphone, table, computer, or smart speaker. A Delivery Device Delivery Product Module 142 that receives the customer order, payment options, store location, and jobsite location from the Order Generation System 114. A Delivery Device Product Database 144 which contains the customer order as well as the store location. A Delivery Device Client Database 146 which contains the payment options for the customer and the jobsite location. The Delivery Device Delivery GUI 148 or graphical user interface(s) may either accept inputs from users or provide outputs to the users, or may perform both the actions. In one case, a user can interact with the interface(s) using one or more user-interactive objects and devices. The user-interactive objects and devices may comprise user input buttons, switches, knobs, levers, keys, trackballs, touchpads, cameras, microphones, motion sensors, heat sensors, inertial sensors, touch sensors, or a combination of the above. Further, the interface(s) may either be implemented as a Command Line Interface (CLI), a Graphical User Interface (GUI), a voice interface, or a web-based user-interface. A Delivery Device GPS 150 or Global Positioning System which is used to determine the location of the Delivery Device. 3rd Party Vendors 152 which are stores that contain materials and supplies for the customer, for example for contractors the 3rd Party Vendors 152 may Home Depot, Lowes, etc. A 3^{rd} Party Vendor 3rd Party Module 154 which connects to the Ordering Platform 102 and sends the 3^{rd} Party Vendor 3rd Party Database 156 to the Ordering Platform Inventory System 108 and receives a customer order and payment if the customer selected to pick up the materials and supplies. A 3^{rd} Party Vendor 3rd Party Database 156 which contains the 3rd Party Vendors 152 available inventory at the store location. The Communication Network 158 may be a wired and/or a wireless network. The Communication Network 158, if wireless, may be implemented using communication techniques such as Visible Light Communication (VLC), Worldwide Interoperability for Microwave Access (WiMAX), Long Term Evolution (LTE), Wireless Local Area Network (WLAN), Infrared (IR) communication, Public Switched Telephone Network (PSTN), Radio waves, and other communication techniques known in the art. The Communication Network 158 may allow ubiquitous access to shared pools of configurable system resources and higher-level services that can be rapidly provisioned with minimal management effort, often over Internet and relies on sharing of resources to achieve coherence and economies of scale, like a public utility, while third-party clouds enable organizations to focus on their core businesses instead of expending resources on computer infrastructure and maintenance.

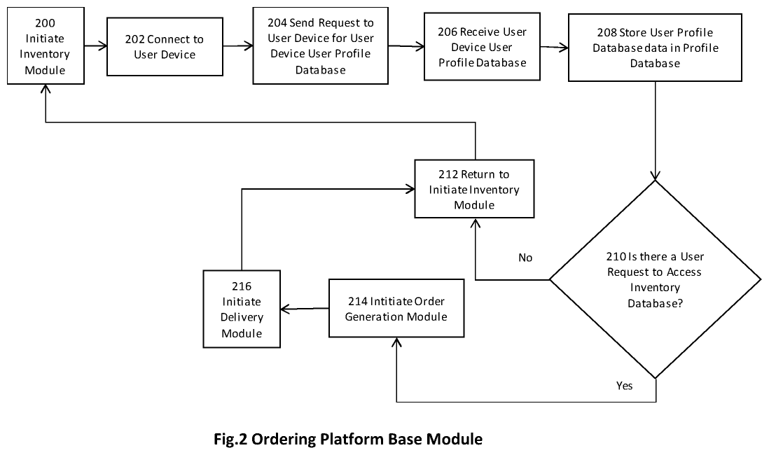

Functioning of the Ordering Platform Base Module 104 will now be explained with reference to FIG. 2. One skilled in the art will appreciate that, for this and other processes and methods disclosed herein, the functions performed in the processes and methods may be implemented in differing order. Furthermore, the outlined steps and operations are only provided as examples, and some of the steps and operations may be optional, combined into fewer steps and operations, or expanded into additional steps and operations without detracting from the essence of the disclosed embodiments.

This figure displays the Ordering Platform Base Module 104. The process begins with initiating the Ordering Platform Inventory Module 110, at step 200. The Ordering Platform Base Module 104 connects to the User Device 126, at step 202. A request is sent to the User Device 126 for the User Device User Profile Database 130, at step 204. The User Device User Profile Database 130 is received, at step 206. The User Profile Database 130 data is stored in the Ordering Platform Profile Database 106, at step 208. Then it is determined if there is a user request to access the Ordering Platform Inventory Database 112, at step 210. If not, the process returns to step 200, at step 212. If yes, the Ordering Platform Order Generation Module 114 is initiated, at step 214. The Ordering Platform Delivery Module 120 is initiated, at step 216.

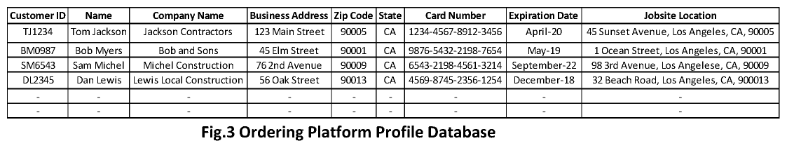

Functioning of the Ordering Platform Profile Database 106 will now be explained with reference to FIG. 3. One skilled in the art will appreciate that, for this and other processes and methods disclosed herein, the functions performed in the processes and methods may be implemented in differing order. Furthermore, the outlined steps and operations are only provided as examples, and some of the steps and operations may be optional, combined into fewer steps and operations, or expanded into additional steps and operations without detracting from the essence of the disclosed embodiments.

This figure displays the Ordering Platform Profile Database 106. The database contains the information from the various customers that use the Ordering Platform 102. The database contains the customer ID, name, company name, business address, zip code, state, card number, expiration, and jobsite location, at step 300.

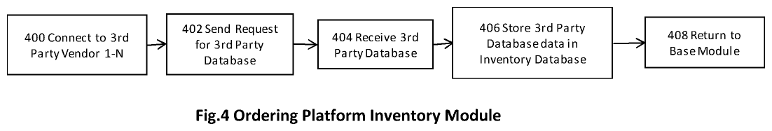

Functioning of the Ordering Platform Inventory Module 110 will now be explained with reference to FIG. 4. One skilled in the art will appreciate that, for this and other processes and methods disclosed herein, the functions performed in the processes and methods may be implemented in differing order. Furthermore, the outlined steps and operations are only provided as examples, and some of the steps and operations may be optional, combined into fewer steps and operations, or expanded into additional steps and operations without detracting from the essence of the disclosed embodiments.

This figure displays the Ordering Platform Inventory Module 110. The process begins with connecting to the 3rd Party Vendor 1-N 152, at step 400. A request is sent for the 3^{rd} Party Vendor 3rd Party Database 156, at step 402. The 3^{rd} Party Vendor 3rd Party Database 156 is received, at step 404. The 3^{rd} Party Vendor 3rd Party Database 156 data is stored in the Ordering Platform Inventory Database 112, at step 406. The process returns to the Ordering Platform Base Module 104, at step 408.

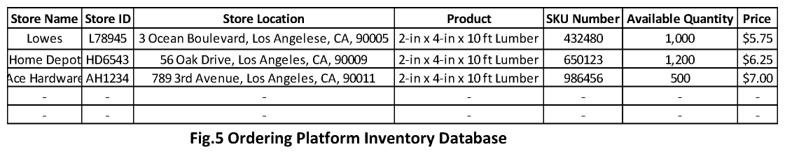

Functioning of the Ordering Platform Inventory Database 112 will now be explained with reference to FIG. 5. One skilled in the art will appreciate that, for this and other processes and methods disclosed herein, the functions performed in the processes and methods may be implemented in differing order. Furthermore, the outlined steps and operations are only provided as examples, and some of the steps and operations may be optional, combined into fewer steps and operations, or expanded into additional steps and operations without detracting from the essence of the disclosed embodiments.

This figure displays the Ordering Platform Inventory Database 112. The database is created from receiving the inventory data from the various 3rd Party Vendors 152. The database contains the store name, store ID, store location, product, SKU number, available quantity, and price per item, at step 500.

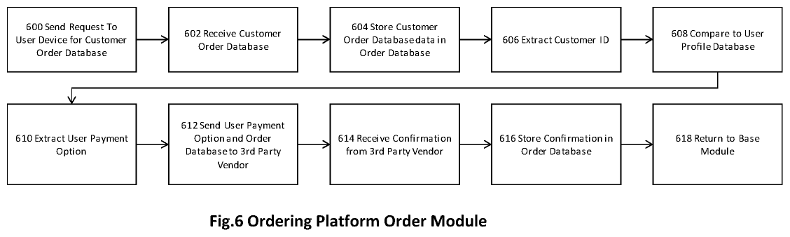

Functioning of the Ordering Platform Order Module 116 will now be explained with reference to FIG. 6. One skilled in the art will appreciate that, for this and other processes and methods disclosed herein, the functions performed in the processes and methods may be implemented in differing order. Furthermore, the outlined steps and operations are only provided as examples, and some of the steps and operations may be optional, combined into fewer steps and operations, or expanded into additional steps and operations without detracting from the essence of the disclosed embodiments.

This figure displays the Ordering Platform Order Module 116. The process begins with sending a request to the User Device 126 for the User Device Customer Order Database 134, at step 600. The User Device Customer Order Database 134 is received, at step 602. The User Device Customer Order Database 134 data is stored in the Ordering Platform Order Database 118, at step 604. The customer ID is extracted from the Ordering Platform Order Database 118, at step 606. The customer ID is compared to the Ordering Platform Profile Database 106, at step 608. The user payment option is extracted from the Ordering Platform Profile Database 106, at step 610. The user payment option and Ordering Platform Order Database 118 is sent to the 3rd Party Vendor 1-N 152, at step 612. The confirmation from 3rd Party Vendor 1-N 152 is received, at step 614. The confirmation is stored in the Ordering Platform Order Database 118, at step 616. The process returns to the Ordering Platform Base Module 104, at step 618.

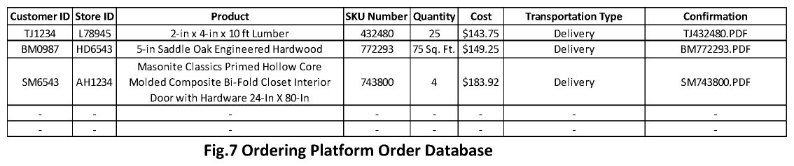

Functioning of the Ordering Platform Order Database 118 will now be explained with reference to FIG. 7. One skilled in the art will appreciate that, for this and other processes and methods disclosed herein, the functions performed in the processes and methods may be implemented in differing order. Furthermore, the outlined steps and operations are only provided as examples, and some of the steps and operations may be optional, combined into fewer steps and operations, or expanded into additional steps and operations without detracting from the essence of the disclosed embodiments.

This figure displays the Ordering Platform Order Database 118. The database is created from connecting to the various User Devices 126 and receiving the User Device Customer Order Databases 134 which contain the customer's order. The database contains the customer ID, store ID, product, SKU number, quantity, total cost, transportation type, and confirmation which is added to the database once received from the 3rd Party Vendor 152, at step 700.

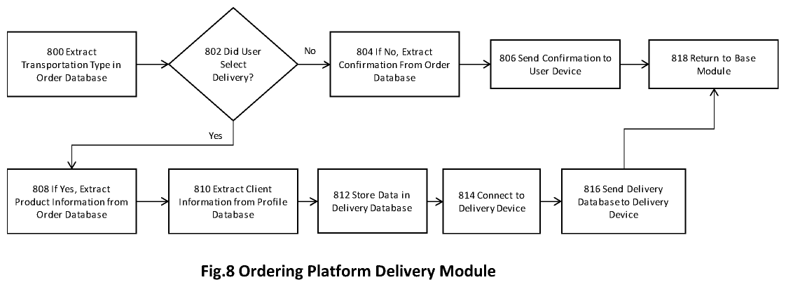

Functioning of the Ordering Platform Delivery Module 122 will now be explained with reference to FIG. 8. One skilled in the art will appreciate that, for this and other processes and methods disclosed herein, the functions performed in the processes and methods may be implemented in differing order. Furthermore, the outlined steps and operations are only provided as examples, and some of the steps and operations may be optional, combined into fewer steps and operations, or expanded into additional steps and operations without detracting from the essence of the disclosed embodiments.

This figure displays the Ordering Platform Delivery Module 122. The process begins with extracting the transportation type in the Ordering Platform Order Database 118, at step 800. It is determined if the user selected delivery, at step 802. If delivery was not selected, the confirmation is extracted from the Ordering Platform Order Database 118, at step 804. The confirmation is sent to the User Device 126, at step 806. If delivery was selected, the product information is extracted from the Order Database 118, at step 808. The client information is extracted from the Ordering Platform Profile Database 106, at step 810. The data extracted from the Ordering Platform Order Database 118 and Ordering Platform Profile Database 106 is stored in the Ordering Platform Delivery Database 124, at step 812. The Ordering Platform Delivery Module 122 connects to the Delivery Device 140, at step 814. The Ordering Platform Delivery Database 124 is sent to the Delivery Device 140, at step 816. The process returns to the Ordering Platform Base Module 104, at step 818.

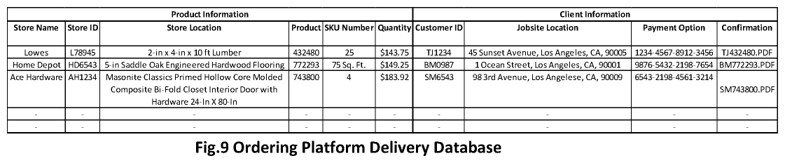

Functioning of the Ordering Platform Delivery Database 124 will now be explained with reference to FIG. 9. One skilled in the art will appreciate that, for this and other processes and methods disclosed herein, the functions performed in the processes and methods may be implemented in differing order. Furthermore, the outlined steps and operations are only provided as examples, and some of the steps and operations may be optional, combined into fewer steps and operations, or expanded into additional steps and operations without detracting from the essence of the disclosed embodiments.

This figure displays the Ordering Platform Delivery Database 124. The database is created from receiving the product information from the Ordering Platform Order Database 118 and the client information from the Ordering Platform Profile Database 106. The database contains the product information of the order which is the store name, store ID, store location, product, SKU number, Quantity. The database also contains the client information which is the customer ID, jobsite location, payment option, and confirmation, at step 900.

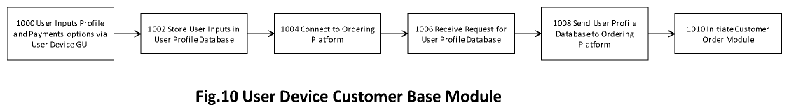

Functioning of the User Device Customer Base Module 128 will now be explained with reference to FIG. 10. One skilled in the art will appreciate that, for this and other processes and methods disclosed herein, the functions performed in the processes and methods may be implemented in differing order. Furthermore, the outlined steps and operations are only provided as examples, and some of the steps and operations may be optional, combined into fewer steps and operations, or expanded into additional steps and operations without detracting from the essence of the disclosed embodiments.

This figure displays the User Device Customer Base Module 128. The process begins with the profile and payments options are inputted by the user via User Device Customer GUI 136, at step 1000. The user inputs are stored in the User Device User Profile Database 130, at step 1002. The User Device Customer Base Module 128 connects to the Ordering Platform 102, at step 1004. A request for the User Device User Profile Database 130 is received, at step 1006. The User Device User Profile Database 130 is sent to the Ordering Platform 102, at step 1008. The User Device Customer Order Module 132 is initiated, at step 1010.

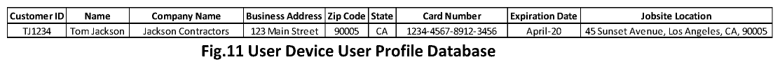

Functioning of the User Device User Profile Database 130 will now be explained with reference to FIG. 11. One skilled in the art will appreciate that, for this and other processes and methods disclosed herein, the functions performed in the processes and methods may be implemented in differing order. Furthermore, the outlined steps and operations are only provided as examples, and some of the steps and operations may be optional, combined into fewer steps and operations, or expanded into additional steps and operations without detracting from the essence of the disclosed embodiments.

This figure displays the User Device User Profile Database 130. The database is created from storing the user inputs through the User Device Customer GUI 136 during the User Device Customer Base Module 128. The database contains the customer ID, name, company name, business address, zip code, state, card number, expiration date, and jobsite location, at step 1100.

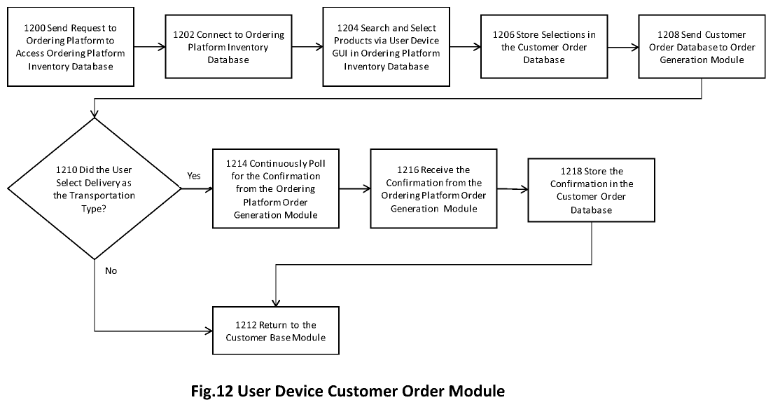

Functioning of the User Device Customer Order Module 132 will now be explained with reference to FIG. 12. One skilled in the art will appreciate that, for this and other processes and methods disclosed herein, the functions performed in the processes and methods may be implemented in differing order. Furthermore, the outlined steps and operations are only provided as examples, and some of the steps and operations may be optional, combined into fewer steps and operations, or expanded into additional steps and operations without detracting from the essence of the disclosed embodiments.

This figure displays the User Device Customer Order Module 132. The process begins with a request is sent to the Ordering Platform 102 to access Ordering Platform Inventory Database 112, at step 1200. The User Device Customer Order Module 132 connects to the Ordering Platform Inventory Database 112, at step 1202. Searching and selecting the desired products via User Device Customer GUI 136 in the Ordering Platform Inventory Database 112, at step 1204. The selections are stored in the User Device Customer Order Database 134, at step 1206. The User Device Customer Order Database 134 is sent to the Ordering Platform Order Module 114, at step 1208. It is determined if the user select delivery as the transportation type, at step 1210. If delivery was selected, the process returns to the User Device Customer Base Module 128, at step 1212. If delivery was not selected, the User Device Customer Order Module 132 continuously polls for the confirmation from the Ordering Platform Order Module 114, at step 1214. The confirmation is received from the Ordering Platform Order Module 114, at step 1216. The confirmation is stored in the User Device Customer Order Database 134 and the process continues to step 1212, at step 1218.

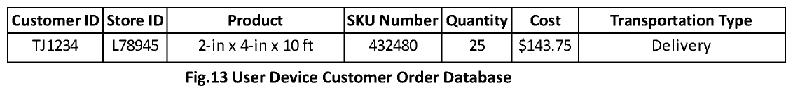

Functioning of the User Device Customer Order Database 134 will now be explained with reference to FIG. 13. One skilled in the art will appreciate that, for this and other processes and methods disclosed herein, the functions performed in the processes and methods may be implemented in differing order. Furthermore, the outlined steps and operations are only provided as examples, and some of the steps and operations may be optional, combined into fewer steps and operations, or expanded into additional steps and operations without detracting from the essence of the disclosed embodiments.

This figure displays the User Device Customer Order Database 134. The database is created through storing the customer's selections via the User Device Customer GUI 136 through the User Device Customer Order Module 132. The database contains the customer ID, store ID, product, SKU number, quantity, total cost, and transportation type, at step 1300.

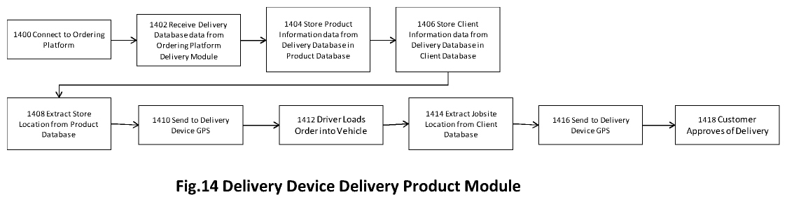

Functioning of the Delivery Device Delivery Product Module 142 will now be explained with reference to FIG. 14. One skilled in the art will appreciate that, for this and other processes and methods disclosed herein, the functions performed in the processes and methods may be implemented in differing order. Furthermore, the outlined steps and operations are only provided as examples, and some of the steps and operations may be optional, combined into fewer steps and operations, or expanded into additional steps and operations without detracting from the essence of the disclosed embodiments.

This figure displays the Delivery Device Delivery Product Module 142. The process begins with the Delivery Device Delivery Product Module 142 connecting to the Ordering Platform 102, at step 1400. The Ordering Platform Delivery Database 124 data is received from the Ordering Platform Delivery Module 122, at step 1402. The product information data from the Ordering Platform Delivery Database 124 is stored in the Delivery Device Product Database 144, at step 1404. The client information data from Ordering Platform Delivery Database 124 is stored in the Delivery Device Client Database 146, at step 1406. The store location from Delivery Device Product Database 144 is extracted, at step 1408. The store location is sent to the Delivery Device GPS 150, at step 1410. The driver loads the customer's order onto the vehicle, at step 1412. The jobsite location from the Delivery Device Client Database 146 is extracted, at step 1414. The jobsite location is sent to the Delivery Device GPS 150, at step 1416. The customer approves of the delivery, at step 1418.

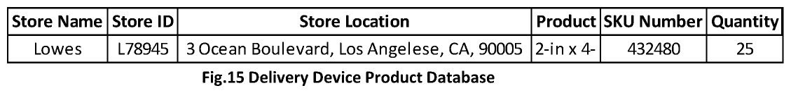

Functioning of the Delivery Device Product Database 144 will now be explained with reference to FIG. 15. One skilled in the art will appreciate that, for this and other processes and methods disclosed herein, the functions performed in the processes and methods may be implemented in differing order. Furthermore, the outlined steps and operations are only provided as examples, and some of the steps and operations may be optional, combined into fewer steps and operations, or expanded into additional steps and operations without detracting from the essence of the disclosed embodiments.

This figure displays the Delivery Device Product Database 144. The database is created through receiving the Ordering Platform Delivery Database 124 in the Delivery Device Delivery Product Module 122. The database contains the store name, store ID, store location, product, SKU number, and quantity, at step 1500.

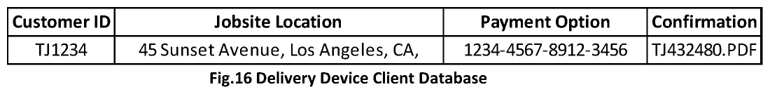

Functioning of the Delivery Device Client Database 146 will now be explained with reference to FIG. 16. One skilled in the art will appreciate that, for this and other processes and methods disclosed herein, the functions performed in the processes and methods may be implemented in differing order. Furthermore, the outlined steps and operations are only provided as examples, and some of the steps and operations may be optional, combined into fewer steps and operations, or expanded into additional steps and operations without detracting from the essence of the disclosed embodiments.

This figure displays the Delivery Device Client Database 146. The database is created through receiving the Ordering Platform Delivery Database 124 in the Delivery Device Delivery Product Module 122. The database contains the customer ID, jobsite location, payment option, and confirmation, at step 1600.

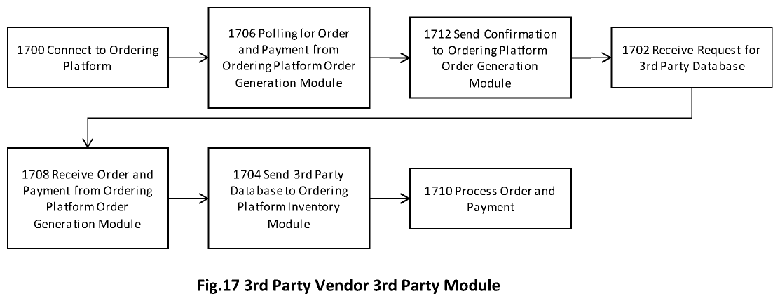

Functioning of the 3^{rd} Party Vendor 3rd Party Module 154 will now be explained with reference to FIG. 17. One skilled in the art will appreciate that, for this and other processes and methods disclosed herein, the functions performed in the processes and methods may be implemented in differing order. Furthermore, the outlined steps and operations are only provided as examples, and some of the steps and operations may be optional, combined into fewer steps and operations, or expanded into additional steps and operations without detracting from the essence of the disclosed embodiments.

This figure displays the 3^{rd} Party Vendor 3rd Party Module 154. The process begins with the 3^{rd} Party Vendor 3rd Party Module 154 connecting to the Ordering Platform 102, at step 1700. A request for the 3^{rd} Party Vendor 3rd Party Database 156 is received, at step 1702. The 3^{rd} Party Vendor 3rd Party Database 156 is sent to the Ordering Platform Inventory Module 110, at step 1704. The 3^{rd} Party Vendor 3rd Party Module 154 is continuously polling for the order and payment from the Ordering Platform Order Module 116, at step 1706. The order and payment are received from the Ordering Platform Order Module 116, at step 1708. The order and payment are processed, at step 1710. The confirmation is sent to the Ordering Platform Order Module 116, at step 1712.

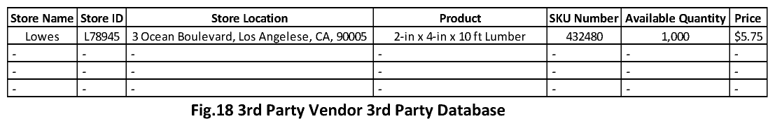

Functioning of the 3^{rd} Party Vendor 3rd Party Database 156 will now be explained with reference to FIG. 18. One skilled in the art will appreciate that, for this and other processes and methods disclosed herein, the functions performed in the processes and methods may be implemented in differing order. Furthermore, the outlined steps and operations are only provided as examples, and some of the steps and operations may be optional, combined into fewer steps and operations, or expanded into additional steps and operations without detracting from the essence of the disclosed embodiments.

This figure displays the 3^{rd} Party Vendor 3rd Party Database 156. The database the inventory data for the 3rd Party Vendor 152 which lists products and quantities available at the specific store location. The database contains the store name, store ID, store location, product, SKU number, available quantity, and price per item, at step 1800.

What is claimed is:

1. A method for providing supplies directly to specific location comprising:
providing a contractor based ordering platform, and
providing a user device, and
providing 3rd party vendors, and
providing a delivery device, and
searching the contractor based ordering platform inventory database via a user device, and
obtaining the contractor location, and
selecting desired products, and
storing the desired products on the user device, and
sending the products to the contractor based ordering platform, and
processing the order and payment on the contractor based ordering platform order module, and
sending the product and client information to the delivery device, and
delivering the desired products to the user device location using the delivery device.

2. An ordering platform base module of claim 1 comprising:
initiating the inventory module
connecting to the user device
sending a request to the user device for user device user profile database
receiving the user device user profile database
storing the user profile database data in ordering platform profile database
determining if there is a user request to access inventory database
if not return to initiating inventory module
if yes initiating order generation module
initiating delivery module

3. An inventory module of claim 1 comprising:
connecting to the 3rd party vendor 1-n
sending a request for the 3rd party database
receiving the 3rd party database
storing the 3rd party database data in inventory database
returning to ordering platform base module

4. An order module of claim 1 comprising:
sending a request to the user device for customer order database
receiving the customer order database
storing customer order database data in the order database
extracting the customer id
comparing the customer id to the ordering platform profile database
extracting the user payment option from the ordering platform profile database
sending user payment option and order database to 3rd party vendor
receiving the confirmation from 3rd party vendor
storing the confirmation in order database
returning to the ordering platform base module

5. A delivery module of claim 1 comprising:
extracting the transportation type in order database
determining if the user selected delivery
if delivery was not selected extracting the confirmation from order database
sending the confirmation to user device
if delivery was selected, extracting the product information from order database
extracting the client information from profile database
storing the data in delivery database
connecting to the delivery device
sending the delivery database to the delivery device
returning to ordering platform base module

6. A customer base module of claim 1 comprising:
inputting the profile and payments options via user device gui
storing user inputs in user profile database
connecting to ordering platform
receiving request for user profile database
sending user profile database to ordering platform
initiating customer order module

7. A customer order module of claim 1 comprising:
sending request to ordering platform to access ordering platform inventory database
connecting to ordering platform inventory database
searching and selecting products via user device customer GUI in ordering platform inventory database
storing selections in the customer order database
sending customer order database to order generation module
determining if the user select delivery as the transportation type
if delivery was selected returning customer base module
if delivery was not selected continuously polling for the confirmation from the ordering platform order module
receiving the confirmation from the ordering platform order module
storing the confirmation in the customer order database

8. A delivery product module of claim 1 comprising:
connecting to ordering platform
receiving delivery database data from ordering platform delivery module
storing product information data from delivery database in product database
storing client information data from delivery database in client database
extracting store location from product database
sending to delivery device GPS
loading materials onto vehicle
extracting jobsite location from client database
sending to delivery device GPS
approval of delivery

9. A 3rd party module of claim 1 comprising
connecting to ordering platform
receiving a request for 3rd party database
sending 3rd party database to ordering platform inventory module
polling for order and payment from ordering platform order generation module
receiving order and payment from ordering platform order generation module
processing order and payment
sending confirmation to ordering platform order generation module
